(19) United States
(12) Patent Application Publication
(10) Pub. No.: US 2022/0315740 A1
(43) Pub. Date: Oct. 6, 2022

(54) A FUNCTIONAL COMPOSITE AND A METHOD FOR PREPARING THEREOF

(71) Applicant: Turing Kimya Endustri Sanayi ve Ticaret Annonim Sirketi, Istanbul (TR)

(72) Inventor: Muhammet Emin CAGLAR, Istanbul (TR)

(21) Appl. No.: 17/295,150

(22) PCT Filed: May 23, 2020
(86) PCT No.: PCT/TR2020/050451

§ 371 Date: May 19, 2021

(51) Int. Cl. C08K 13/00; G21F 1/10; C08K 3/34; C08K 3/24; B29C 43/00

(52) U.S. Cl. CPC C08K 13/00; G21F 1/10; C08K 3/34; C08K 3/24; B29C 43/003; C08K 2003/222

(57) ABSTRACT

A composite material that prevents the emission of the radiation and a production method thereof. The composite material which prevents the emission of the radiation mainly includes boric acid, sodium pentaborate, barium sulphate, tribasic lead sulphate, zeolite, zinc borate as anti-odour and/or gas suppressor, at least one thermoset component for hardness ability or thermoplastic component for flexibility ability and preferably magnesium oxide, barium titanate and titanium dioxide.

### TECHNICAL FIELD

The invention relates to a functional composite material.

The invention particularly relates to a composite material to be used in sectors such as medicine, defence industry, construction, mining, pharmaceutical industry, civil aviation, and aircraft industry.

### STATE OF THE ART

Lead plates are used for protecting the users, hospital personnel and the patients from the harmful effects of the radiation in devices such as high-energy x-ray emitting radiation, angiography etc. in the hospitals, health centres and research institutions. However, in addition to the benefit provided with the lead plate, it has unignorable harmful effects on human health. The most important harm of the lead is its toxic substance production. The lead which gives chemical, biochemical and radioactive damages to the cells and living tissues is continued to be used in many countries although it has many known harms. World Health Organisation performs studies to promote the gradual removal of its production and sales. The lead powder within the plates used for protection from the radiation irritates the skin, on the other hand it leads to permanent damage to whole immune system by means of respiration. The coatings made on the lead are abraded in time since it is subjected to corrosion, which causes release of toxic gases.

In order to minimize this damage caused by lead, there are two main applications. The first application among the current applications is to fix the lead plates which are used with a determined thickness based on the amount of powerful radiation (x rays) to be emitted by the machine, on the walls by means of iron profiles. In this application, lead plates are mounted between the profiles and the wall and the upper portion thereof is covered with plaster boards. The second application is to place the lead plates between two block walls in case a higher amount of x ray based on the capacity of the machine is applied. Moreover, this coating is applied in aluminium profile, lead plate or paraffin form at the points where the release is higher.

In known applications, there are problems such as difficulties in application and the material's being subject to corrosion in a short period of time. When lead is applied to the movable furniture (for example doors), its weight increases based on its high density. This reduces the economic life of the door and damages the hinges of the door.

In the present state of the art, there are many studies on this subject matter. For example Turkish Patent Application numbered 2017/07064 is related to a nano-particle containing elastomer structured radiation protective material and it is developed to be used in the production of equipment such as apron, gloves, thyroid, gonad protector from lead used for the protection from the radiation that the employees are exposed to within their working environment. Herein, a radiation protective material having X-ray/Gamma radiation shielding feature with the addition of nano-sized lead oxide particle and bismuth oxide of the elastomer structured material which has equivalent properties with the lead material is developed. However, since lead is a heavy material, it reduces the economic life on the surface it is applied and damages the structure by means of causing a serious pressure on the surface.

Another example is the patent application numbered US 2010/0102279. This document discloses increasing the radiation shielding capacity of nano structures to be produced by means of the pulverisation method by means of adding the same in metal or polymeric materials. Nano iron, nano tungsten and nano lead particles are disclosed as light structured radiation protective materials.

Another example is the Turkish patent document numbered TR 2018/17304. In the invention disclosed in this document, the composite material to be prepared by means of combining the rocks and soils found naturally in nature and the radiation shielding production and method are described.

U.S. Pat. No. 4,647,714A is related to the composite sheet material for magnetic and electronic shielding. The composite sheet material used for protecting the magnetism and electromagnetic waves described herein, is basically made of an iron foil which is electrodeposited as a core, has 10 urn thickness, is applied on both side surfaces of a coating material having a predetermined metal.

Patent document numbered CN105390171B is related to a ceramic radiation shielding material and preparation method of chemical bonding. The product developed by the invention is formed at room temperature, here the combination of the substance comprises “cold sintering”, chemical bonding and oxide-phosphate ceramic cement matrix.

In the present state of the art, some composites which also prevent the radiation emissions more effectively compared to lead panels are used. As examples to these, composite materials obtained by using iron powder, tungsten carbide, silicone, tribasic lead sulphate can be considered. It is very harmful to human health since these metals used are included within the heavy metal class. Also, there may be problems in production cost and usage capability of these metals. In addition to this, easy rotation cannot be given to these systems; they also do not have flexibility. This limits usage area thereof.

As a result, due to the abovementioned disadvantages and the insufficiency of the current solutions regarding the subject matter, a development is required to be made in the relevant technical field in term of new materials which prevent radiation emitting.

### AIM OF THE INVENTION

The present invention is related to a composite material which fulfils the abovementioned requirements, eliminates all disadvantages, and brings some additional advantages.

The main aim of the invention is to develop a composite material which prevents the emission of the radiation.

Another aim of the invention is to develop a composite material which does not affect the human health negatively.

Another aim of the invention is to develop a composite material which has an elastic structure due to the polymeric compound within its content and thus is easy to assemble and be formed into wearable components.

Another aim of the invention is to develop a durable and low cost composite material.

The invention covers a composite material that prevents the emission of the radiation and a production method thereof in order to fulfil the abovementioned aims. The composite material for preventing the emission of the radiation mainly comprises boric acid, sodium pentaborate, barium sulphate, tribasic lead sulphate, zeolite, zinc borate as anti-odour and/or gas suppressor, at least one thermoset component for hardness ability and/or thermoplastic component for flexibility ability. Preferred embodiments of the invention also comprise magnesium oxide and/or barium titanate and/or titanium dioxide.

The method for preparing the invented composite material that prevents the emission of the radiation comprises following process steps:
grinding the mixture containing boric acid, sodium pentaborate, barium sulphate, tribasic lead sulphate, zeolite and zinc borate within the grinder containers and performing dispersion by means of adding water;
adding at least one thermoset component for hardness and/or at least one thermoplastic component for elasticity in the powder mixture and pouring the same into the moulds;
pouring the mixture which is poured into the moulds and comprises thermoset component into the moulds, vacuuming the same and curing the vacuumed mixture; and/or
exposing the mixture which is poured into moulds and contains thermoplastic component to a high pressure between 10-50 tons in the press machine,
extruding the compound (thermoplastic component and radiation shielding powders together) and producing the panels directly.

The structural and characteristic features of the present invention will be understood clearly by the following detailed description and the figures. Therefore, the evaluation shall be made by taking detailed description the figures and into consideration.

### FIGURES CLARIFYING THE INVENTION

FIG. 1: Thermoset composite process flow chart

FIG. 2: Thermoplastic composite process flow chart

### DESCRIPTION OF THE PART REFERENCES

1 Grinder Container
2 Thermoset Components
3 Thermoplastic Components
4 Press Machine
5 Mould

### DETAILED DESCRIPTION OF THE INVENTION

In this detailed description, the preferred embodiments of the inventive composite material that prevents emission of the radiation is described only for clarifying the subject matter in a manner such that no limiting effect is created.

Together with the invention, a composite material that prevents the emission of the radiation is developed. The inventive material mainly comprises, boric acid, sodium pentaborate, barium sulphate, tribasic lead sulphate, zeolite, zinc borate as anti-odour and/or gas suppressor, at least one thermoset component (2) for hard structures or thermoplastic component (3) for flexible components.

A preferred example of the invention is given in Table 1 and the material developed for this comprises the following by weight relative to the total weight. Proposed particulate mixture will be evenly distributed in thermoplastic/thermoset polymeric resins:
boric acid in a ratio of 2-10% (more preferably 10%),
sodium pentaborate in a ratio of 6-19% (more preferably 19%),
magnesium oxide in a ratio of 0.2-2% (more preferably 2%),
tribasic lead sulphate in a ratio of 0.1-1% (more preferably 1%),
zinc borate in a ratio of 0.3-9% (more preferably 9%),
barium titanate in a ratio of 3-7% (more preferably 7%),
titanium dioxide in a ratio of 0.7-8% (more preferably 8%),
zeolite in a ratio of 5-18% (more preferably 18%) and
barium sulphate in a ratio of 0.5-26 (more preferably 26%).

| | Usable amount | Preferred amount |
|---|---|---|
| Name of the component | by weight | by weight |
| Boric acid | 2-10% | 10% |
| Sodium Pentaborate | 6-19% | 19% |
| Magnesium Oxide | 0.2-2% | 2% |
| Tribasic Lead Sulphate | 0.1-1% | 1% |
| Zinc borate | 0.3-9% | 9% |
| Barium Titanate | 3-7% | 7% |
| Titanium Dioxide | 0.7-8% | 8% |
| Zeolite | 5-18% | 18% |
| Barium sulphate | 0.5-26% | 26% |

In a preferred embodiment of the invention, said thermoplastic component (3) is selected from a group comprising: ethylene vinyl acetate (EVA), polyamide, polyacrylic rubber, silicone rubber, nitrile rubber, fluorocarbon rubber, polyvinylchloride, polypropylene, polyethylene, propylene or combinations thereof. These components give flexibility and lightness to the final product.

In a preferred embodiment of the invention, said thermoset component (2) is selected from a group comprising epoxy, unsaturated polyester, polytetrafluoroethylene, styrene butadiene rubber, polyurethane, or combinations thereof. These components give hardness capability to the final product.

Together with the invention, a method for preparing a composite material that prevents the emission of the radiation is developed. The method mainly comprises the following process steps;
grinding the mixture containing boric acid, sodium pentaborate, barium sulphate, tribasic lead sulphate, zeolite and zinc borate within the grinder containers (1) and performing dispersion by means of adding water;
preferably adding at least one thermoset component (2) or at least one thermoplastic component (3) in the powder mixture and pouring the same into the moulds;
pouring the mixture which is poured into the moulds and comprises thermoset component (2) into the moulds (5), vacuuming the same at preferably a temperature between 50-55° C. and curing the vacuumed mixture preferably for 1-5 hours; or
exposing the mixture which is poured into moulds and contains thermoplastic component (3) to preferably a high pressure of 10-50 tons within moulds with 3 mm inner thickness and 20×20 dimensions at a temperature preferably between 100-200° C. for 1 hours in the press machine (4),
extruding the compound (thermoplastic component and radiation shielding powders together) and producing the panels directly.

Grinding the mixture containing boric acid, sodium pentaborate, barium sulphate, tribasic lead sulphate, and zeolite and zinc borate within the grinder containers (1) and performing dispersion by means of adding water; The grinding process performed here is continued until the particle size is 1 micron. Preferably dispersion is carried out for 5-24 hours by means of adding water into the powder mixture which is grinded and thus the particle size is reduced. The components contained in the mixture interact and mix with each other by means of dispersion. An unpleasant odour/gas release occurs during the formation of dispersion. The zinc borate in the dispersion eliminates this odour and suppresses the gas. Following this process, at least one component is selected from the thermoplastic components (3) for flexibility and from the thermoset components (2) for hardness and these are added into the powder mixture.

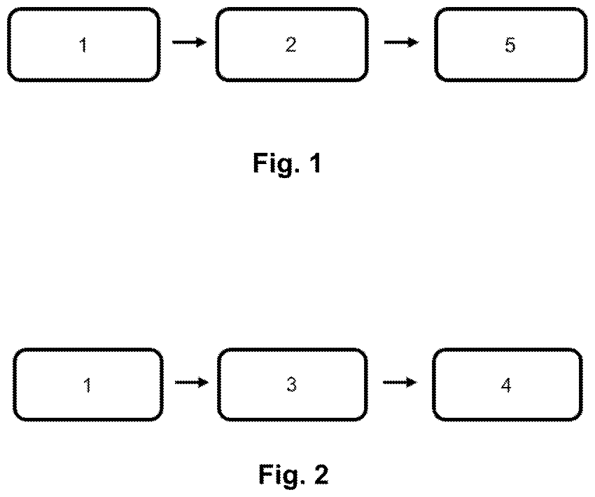

In an exemplary embodiment of the invention, the process steps for the product containing thermoset component (2) is as follows; pouring the prepared fluid formula into the moulds (5), vacuuming at a temperature between 50-55 C and removing the air bubbles in it and then leaving the same in the oven for curing. After the material is cured, two materials are welded to each other by extrusion welding, are mounted on the wall or covered on the same. The thermoset composite process flow chart is given in FIG. 1.

In an exemplary embodiment of the invention, the process steps for the product containing thermoplastic component (3) is as follows; pouring the prepared granule formula in the metallic moulds, dispersing the same in a homogenous manner and putting the same in the hot press machine (4) and exposing the same to pressing at high temperature (preferably 100-200° C.) and high pressure (preferably 10-50 tons). Then it shall be removed from the mould and left for cooling. These operations last in 1-5 hours in total. Thermoplastic composite process flow chart is given in FIG. 2.

The product samples achieved by means of the present invention are tested within the framework of IEC 61331-1:2005 standard and it is seen that the composite materials confirm the standards in terms of the radiation shielding of the obtained composite material. Details in relation with the irradiation system and standard dosimeter are given in Table 1 and the test measurements of the material are given in Table 2 and Table 3.

TABLE 1

| | |
|---|---|
| X ray system | YXLON MGC 41 |
| Radiation quality | 150 Kv 10 Ma, (IEC 61331-1) |
| Standard dosimeter | PTV UNIDOSE E T10008 #81049 + PTW |
| | 7861 # 008 XXX CC 400 V |

TABLE 2

| | lead-free product according | |
|---|---|---|
| | to the invention (1 mm | |
| | thickness 10 × 10 mm | 0.5 mm |
| | dimensions) | Standard Lead |
| Radiation shielding (%) | 91% | 94% |

TABLE 3

| | lead-free product according | |
|---|---|---|
| | to the invention (0.5 mm | |
| | thickness 15 × 15 mm | 0.25 mm |
| | dimensions) | Standard Lead |
| Radiation shielding (%) | 78% | 82% |

The negative effects of the lead on human health are eliminated by this product with our invention. A durable, low cost product is obtained with this product. The product has an elastic structure with the thermoplastic component (3) that it contains. This provides extension of assembly and usage areas. Its application and renewal are easy due to its being light weight.

1. A composite material for preventing the emission of the radiation comprising boric acid, sodium pentaborate, barium sulphate, tribasic lead sulphate, zeolite, zinc borate as anti-odour and/or gas suppressor, at least one thermoset component for hardness ability or thermoplastic component for flexibility ability.

2. The composite material according to claim 1, further comprising magnesium oxide.

3. The composite material according to claim 1, further comprising barium titanate.

4. The composite material according to claim 1, further comprising titanium dioxide.

5. The composite material according to claim 1, comprising boric acid in an amount of 2-10% ratio by weight relative to the total weight.

6. The composite material according to claim 5, wherein a boric acid ratio is 10%.

7. The composite material according to claim 1, comprising sodium pentaborate in an amount of 6-19% ratio by weight relative to the total weight.

8. The composite material according to claim 7, wherein a sodium pentaborate ratio is 19%.

9. The composite material according to claim 2, comprising magnesium oxide in an amount of 0.2-2% ratio by weight relative to the total weight.

10. The composite material according to claim 9, wherein a magnesium oxide ratio is 2%.

11. The composite material according to claim 1, comprising tribasic lead sulphate in an amount of 0.1-1% ratio by weight relative to the total weight.

12. The composite material according to claim 11, wherein a tribasic lead sulphate ratio is 1%.

13. The composite material according to claim 1, comprising zinc borate in an amount of 0.3-9% ratio by weight relative to the total weight.

14. The composite material according to claim 13, wherein a zinc borate ratio is 9%.

15. The composite material according to claim 3, comprising barium titanate in an amount of 3-7% ratio by weight relative to the total weight.

16. The composite material according to claim 15, wherein a barium titanate ratio is 7%.

17. The composite material according to claim 4, comprising titanium dioxide in an amount of 0.7-8% ratio by weight relative to the total weight.

18. The composite material according to claim 15, wherein a titanium dioxide ratio is 8%.

19. The composite material according to claim 1, comprising zeolite in an amount of 5-18% ratio by weight relative to the total weight.

20. The composite material according to claim 19, wherein a zeolite ratio is 18%.

21. The composite material according to claim 1, comprising barium sulphate in an amount of 0.5-26% ratio by weight relative to the total weight.

22. The composite material according to claim 21, wherein a barium sulphate ratio is 26%.

23. The composite material according to claim 1, wherein the thermoplastic component is selected from a group comprising; ethylene vinyl acetate (EVA), polyamide, polyacrylic rubber, silicone rubber, nitrile rubber, fluorocarbon rubber, polyvinylchloride, polypropylene, polyethylene, or combinations thereof.

24. The composite material according to claim 1, wherein; the thermoset component is selected from a group comprising epoxy, unsaturated polyester polytetrafluoroethylene, styrene butadiene rubber, polyurethane, or combinations thereof.

25. A method for preparing a composite material that prevents the emission of the radiation according to any of the preceding claims, comprising following process steps:
grinding the mixture containing boric acid, sodium pentaborate, barium sulphate, tribasic lead sulphate, zeolite, and zinc borate within the grinder containers and performing dispersion by means of adding water;
adding at least one thermoset component for hardness or at least one thermoplastic component for elasticity in the powder mixture and pouring the same into the moulds;
pouring the mixture which is poured into the moulds and comprises thermoset component into the moulds, vacuuming the same and curing the vacuumed mixture;
exposing the mixture which is poured into moulds and contains thermoplastic component to a high pressure between 10-50 tons in the press machine;
extruding the compound (thermoplastic component and radiation shielding powders together and producing the panels directly.

26. The method according to claim 25, wherein dispersion is performed for 5-24 hours.

27. The method according to claim 25, characterized in exposing the mixture which is poured into moulds to pressure within moulds with 3 mm inner thickness and 20×20 dimensions at a temperature preferably between 100-200° C. for 1 hours is carried out.

28. The method according to claim 15, characterized in vacuuming the mixture poured into the moulds and containing thermoset component at a temperature between 50-55° C. is carried out.

29. The method according to claim 15, wherein the vacuumed mixture is cured between 1-5 hours.
